(19) United States
(12) Patent Application Publication
(10) Pub. No.: US 2006/0002051 A1
(43) Pub. Date: Jan. 5, 2006

(54) Electric discharge apparatus and method for ionizing fluid and method of deodorizing and eliminating mold

(76) Inventor: Paul R. Goudy JR., Bayside, WI (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/882,950

(22) Filed: Jul. 1, 2004

(51) Int. Cl. H01H 47/00

(52) U.S. Cl. 361/220

(57) ABSTRACT

An apparatus and method for ionizing fluid including a pair of electric discharge devices through which the fluid may flow while the devices discharge electricity into the fluid. Each of the pair of electric discharge devices includes a field electrode and a discharge electrode. While AC electrical power is provided to the electrodes of the pair of electric discharge devices, one of the electric discharge devices provides electrical discharge into fluid therein during at least a portion of one polarity of the AC electrical power while the other electric discharge device is substantially non-conducting of electrical power, and vice versa during the opposite polarity of power. The invention further relates to a method of deodorizing an area or eliminating mold by providing in the area a gas mixture including a concentration of ionized nitrogen such that it causes a layer of nitric acid to be formed on any moist surfaces in the area or it causes dessication of moist organic material during the formation of a layer of nitric acid.

### TECHNICAL FIELD

The present invention relates generally to a fluid ionizing apparatus and methods for deodorizing and eliminating mold through the use of ionized gas.

### BACKGROUND

Electrical discharge devices have been used in the past to ionize fluid. One example is a device for creating ozone. In an example of such a device, air or pure oxygen is moved between a pair of electrodes, across which an electrical discharge is created to cause the oxygen molecules to ionize and to recombine as ozone. The electrical discharge typically is an electric arc. A problem in the past has been that of controlling the electrical discharge and, thus, the electric arc so as to avoid burning the electrodes and/or other components of the electrical discharge device. In many instances, the electron flow in one electrode (source electrode) tends to seek the point or location of lowest electrical potential relative to the opposing electrode and to jump from the first electrode to the opposing electrode at that point or at several such points without substantially uniformly spreading over the source electrode. The mentioned points or locations become hot spots and may result in burning or other damage to the electrodes in the area of a hot spot. Damage may also occur to any dielectric material disposed between the electrodes. Such damage is a wear factor which reduces the life of the electrical discharge device and the ionizer or other device in which it is used. Thus, it will be appreciated that there is a need for increasing the longevity of electrical discharge devices and the apparatus in which they are used. There also is a need to reduce the occurrence of such hot spots.

Another example of an electrical discharge device is an ionizer in which a fluid is ionized as it flows through a tubular dielectric member. Exemplary tubes may be made of glass, quartz, plastic, or possibly of other materials. The tubular member has a hollow interior along which a fluid may be passed; for example, air or oxygen, in which case the oxygen typically is ionized to create ozone, as mentioned above. In the hollow interior of the tubular member is an electrode, which discharges into the fluid to have the ionizing effect. Another electrode external to the hollow interior of the tubular dielectric member tends to create an electric field so as to promote the electrical discharge, and in some cases tends to steer the direction of that discharge from the interior electrode into the fluid. A number of problems exist in such ionizers, including those mentioned above: namely, the non-uniformity of the electrical discharge, occurrence of hot spots and the damage caused by them, and so forth. Damage may also occur to the dielectric material that is disposed between the electrodes. Also, if the electrical discharge or electric arc occurs only at one or several points along the internal conductor, ionizing only occurs with respect to the relatively small portion of the fluid which passes in the immediate area of the electrical discharge. Therefore, the efficiency of such a device is rather low, and it will be appreciated that there is a need for improved efficiency in such ionizer devices.

One approach to reduce hot spots in the ionizers of the type described above has been to limit the current available for the electrical discharge. However, such limiting may reduce the efficiency of the ionizer and the extent to which it can ionize the fluid. As one example, air is a fluid used in such an ionizer to create ozone. The oxygen in the air is relatively easy to ionize due to the molecular composition and valence characteristics of the oxygen. However, the current-limited ionizer may be unable to ionize other fluids that are more difficult to ionize, such as nitrogen, which is a major component of air. Thus, there is a need to increase the ionizing capabilities of fluid ionizers by some method other than conventional current-limiting.

Conventional electrical discharge devices used to ionize fluids have encountered another problem, in that if the electrical discharge device is supplied with AC electrical power, then one polarity of the input AC electrical power will result in a discharge of electrons into the fluid, but the opposite polarity will attempt to remove electrons. This opposite polarity power will have minimal effect on ionization and will merely operate to create heat. In some instances, diodes have been used to block the unused portion or polarity of the input AC signal, which also wastes part of the input power. This is another motivation for the improvement of the efficiency of electrical discharge devices and the apparatus, systems, and methods for ionization.

Prior efforts to ionize nitrogen, which has a higher ionization potential than oxygen, have encountered the above difficulties. Since a relatively large voltage and current would be needed in order to ionize nitrogen, the problems of hot spots, electrode damage and other inefficiencies increase still further. Thus, there is a need for improved ionizers and electrical discharge devices, as well as methods for the ionization of higher ionization potential fluids, such as nitrogen.

Most existing ozone generators must be very careful to avoid production of nitrogen. If the generators draw the ionized nitrogen gas passed wires or components with exposed insulation, the nitrogen and the byproducts thereof can destroy these wires and components rather rapidly. The gases produced by a nitrogen ionizer are reasonably corrosive. While the gases are not corrosive enough to cause damage after an hour or two in a room, since the apparatus receives continuous exposure, there is a need for a corrosion resistant apparatus.

Ozone has been used to deodorize objects, spaces, such as hotel rooms, and the like. Ozone, however, tends to mask odors; it does not destroy the source of the odor. Therefore, after the ozone dissipates, the odor may return. Thus, there is a need for improved deodorization.

### A BRIEF SUMMARY

According to an aspect of the invention by increasing the ionizer gap width in an ionizing electric discharge device, the device generates a gas mix including a high concentration of ionized nitrogen.

Another aspect relates to the use of ionized nitrogen for odor remediation and elimination of mold.

Natural nitrogen takes the form of a double atom, or a doublet, that can be broken down by adding or removing electrons. When electrons leave the inner electrode in the presence of a higher voltage potential or stronger electric field, they accelerate rapidly. With their high acceleration, upon impingement of the nitrogen molecules (which have a higher ionization potential that oxygen), the electrons have enough energy to rupture the N₂ bond, thereby creating N from N₂. The efficient creation of N is one aspect of the invention.

Problems arise in that higher voltages and wider gaps are wearing on the apparatus. Another aspect of this invention focuses on protecting the apparatus by controlling the wider gap arcs that make the ionized nitrogen possible.

In an ionizer, the gap width is the distance between the outer field electrode and the inner electrode. Glass thickness, while not critical, plays a role in spacing apart the two electrodes and in preventing dielectric burn-through. Another aspect of the invention is to select a gap width and dielectric thickness which will extend the life of the apparatus.

The gap width in the ionizer limits or dictates the breakdown voltage; the breakdown voltage then dictates which gases are being ionized. Water vapor has the lowest ionization potential, followed by oxygen, and then nitrogen. If the breakdown voltage is high enough, water vapor, oxygen, and nitrogen will be ionized. At lower breakdown voltages, ionization of nitrogen is avoided, as in the aforementioned ozone generators. Another aspect of the invention relates to an ionizer with a relatively wide gap and high breakdown voltage to ionize nitrogen.

To produce greater amounts of ionized gas, the voltage of an electric discharge device may be increased. With an input of AC power having a sinusoidal curve, the molecules will break down once the breakdown voltage has been reached and while it is maintained, rather than merely at the peak of the curve. Accordingly, when higher voltages are used, the discharge time between the intersection of the sinusoidal curve and the breakdown voltage increases as a result of a generally more vertical wave pattern. The quantity of the ionized gas is increased as the duration of the discharge time is increased. Another aspect of the invention is the increased amount of ionized gas through extension of the duration of the discharge time.

A problem in ozone generators and other previous ionizer designs is that hotspots occurring at the discharge locations between the electrodes often cause failure of the dielectric material. Increasing the gap width also increases the breakdown voltage and, hence, the velocity and impact of the electron spray against the surface of the dielectric material. In existing devices, high velocity airflow was one of the methods used to blow on the hotspots and cool the dielectric material, but such high velocity airflow reduces ionization in the gas as it passes rapidly through the electric field. Another aspect of the invention relates to an ionizer that can function reliably with relatively low velocity airflow through the ionizer tubes.

The electrical discharge capacity of an ionizer unit may be proportional to the capacitance of a capacitor array within the unit. The discharge usually is limited to the electrons that are stored in the capacitance of the device. Another aspect of the invention relates to increasing the capacitance of the ionizer unit.

Another aspect of the invention relates to an ionizer that includes a generally tubular flow path, in which a fluid may flow between a pair of electrodes. In response to appropriate energization, an electric field occurs between the electrodes, and an electrical discharge into the fluid may occur from a number of discharge sites.

Another aspect of the invention relates to a method for ionizing a fluid by directing the fluid through an ionizer while providing electrical discharge into the fluid from a number of discharge sites.

Another aspect relates to an electrode having a number of discharge sites to provide electrical discharge into a fluid, wherein the discharge sites are charged in series and are able to discharge at least partly in an electrical parallel relation.

Another aspect relates to a method of charging a number of electrical discharge sites in electrical series relation and discharging a number of those discharge sites in substantially electrical parallel relation.

Another aspect relates to an electric discharge apparatus including a source of an electric field, and an electrode positioned within such electric field, and further including an electrically conductive coil having a number of serially connected loops so as to provide substantially separate electric discharge sources.

Another aspect relates to a method of creating a number of electrical discharges which includes: providing an electric field, serially charging a number of electric discharge sources located in the electric field, and electrically discharging a number of those electric discharge sources in parallel.

Another aspect relates to an electric discharge device, which includes a tubular dielectric body having a hollow internal space, an electrode external of the space to provide an electric field in the space, and a further electrode in the space having a plurality of portions for providing respective electrical discharges in the space.

Another aspect relates to a method of preventing charge transfer from one surface to another surface of a coil electrode in an electric discharge device, that method including providing an electric field in which the coil electrode is immersed, and maintaining the electrical potential between contacting surfaces of adjacent loops of the coil electrode at a higher level than the potential between non-contacting surfaces of the adjacent loops from which electric discharge may occur.

Another aspect relates to a method of discharging an arc into a gas flow which includes directing a gas flow longitudinally along an electrode that has respective parts which promote lateral discharge across the electrode into the gas.

Another aspect relates to a method of minimizing heat buildup in a dielectric in an electrical discharge device in which an electrode provides electrical discharge in a direction toward the dielectric, including de-stressing at least a surface portion of the electrode to facilitate substantially random movement of the electrical discharge so as to avoid localized impingement on the dielectric.

Another aspect relates to a method of minimizing heat buildup in a dielectric in an electrical discharge device in which an electrode has a number of electrical discharge sources that provide electrical discharge in a direction toward the dielectric, including using the electrical discharge sources to self-limit the respective electrical discharges.

Another aspect relates to an apparatus for providing electrical discharges including: a tubular dielectric having a hollow interior, an interior electrode located in the hollow interior of the tubular dielectric, said interior electrode comprising a coil extending in an axial direction along the tubular dielectric and having a plurality of loops, and an exterior electrode about the exterior of the tubular dielectric.

Another aspect relates to a method of ionizing a gas, which includes directing a gas flow along an electrode, discharging electrons into the gas at selected locations along the gas flow so as to ionize the gas flowing at those locations, and wherein portions of gas in the gas flow unexposed to the direct discharge of electrons from the electrode provide a fresh source of non-ionized gas to support further discharge and ionization.

Another aspect relates to an electrical discharge apparatus, which includes a source of AC power, a pair of electrodes coupled in opposite polarity relation with respect to the source, a gas into which at least one of the electrodes provides electrical discharge at one polarity of the source, and a gas into which the other of the electrodes provides electrical discharge at the opposite polarity of the source.

Another aspect relates to a method of ionizing a gas, which includes directing a gas flow along a coil electrode that has a plurality of loops, wherein each loop is operable as an electrical discharge source so as to discharge independently into the gas thereby causing ionization; and supplying the electrode with AC electrical power so as to charge respective electrical discharge sources simultaneously for such independent discharging.

Another aspect relates to a gas ionizing apparatus, which includes two banks of ionizing electrodes connected to a source of AC power such that they operate in opposite polarity so that, during the first half of the sinusoidal AC power curve, a first bank fires, and a second bank fires on the second half of the power curve.

Another aspect relates to a gas ionizing apparatus, that is self-contained in a portable, durable, and mobile case, wherein the case is sealed around the edges so as to act as a pressurized plenum.

Another aspect relates to a gas ionizing apparatus, wherein a pressurizing fan blows air directly on the ionizing reactors to cool them before the air is forced through the reactors and out of the case through a port.

Another aspect relates to a gas ionizing apparatus, which includes two banks of reactor tubes, wherein each bank is connected to an AC power source in opposite polarity so as to provide a balanced load to the power source and such that the opposing banks are triggered and discharged alternatively so that the apparatus is discharged 120 times per second when operated using 60 Hz AC power.

Another aspect relates to a gas ionizing apparatus, wherein, without use of a filter a metal oxide on an electrode's surface burns off in operation, thereby making the apparatus tolerant of debris.

Another aspect relates to a method of combining the gas ionization apparatus with a large external fan blowing across the face of the discharge area so as to disperse ionized gas into a room in a swirl distribution for deodorization of the room.

Another aspect relates to a method of flooding a room with ionized gas which contains ionized nitrogen or ionized nitrogen oxides for deodorization and/or the elimination of mold.

Another aspect relates to a method of blending an ionized gas which contains ionized nitrogen or ionized nitrogen oxides with a stream of odorous gas for deodorization of the odorous gas.

Another aspect relates to a method of directing a stream of odorous gas through a self-contained gas ionizing apparatus so as to deodorize the gas.

Another aspect relates to a method of directing a stream of ionized nitrogen or ionized nitrogen oxides into a bag surrounding an item to be deodorized.

Another aspect relates to a gas ionizing apparatus, which includes reactors having a wider arc gap (than typical corona generators used for generating ozone) so as to bias the ionized gas discharge toward ionized nitrogen and ionized oxides of nitrogen.

Another aspect relates to a method for deodorization or the elimination of mold by pumping ionized nitrogen into a room such that a thin layer of nitric acid is formed at the surface of the source of the odor or mold.

The following description and drawings set forth in detail certain illustrative embodiments of the invention, these embodiments being indicative of several of the ways in which the principles of the invention may be employed. A number of features are described herein with respect to several embodiments of the invention. It will be appreciated that features described with respect to a given embodiment also may be employed in connection with other embodiments. These embodiments are indicative, however, of but a few of the various ways in which the principles of the invention may be employed.

These and other features of the invention are fully described and particularly pointed out in the claims.

### BRIEF DESCRIPTION OF THE DRAWINGS

In the annexed drawings:

FIG. 1 is a schematic illustration of an electric discharge device in accordance with an embodiment of the invention for use, for example, as an ionizer;

FIG. 2 is an enlarged fragmentary view of the electric discharge device/ionizer of FIG. 1;

FIG. 3 is a schematic illustration of an AC power signal;

FIGS. 4A and 4B are schematic fragmentary illustrations of the ionization assembly used in the electric discharge device/ionizer of FIGS. 1 and 2, illustrating formation of the electron clouds and electron sprays;

FIGS. 5-11 are schematic illustrations of embodiments of the interior electrode finding application in the electric discharge device/ionizer of FIGS. 1 and 2;

FIGS. 12A, 12B, and 12C are schematic illustrations of an embodiment of the exterior electrode in an electric discharge device/ionizer;

FIG. 13 is a schematic illustration in elevation, partly shown in section, of an ionization system according to an embodiment of the invention;

FIG. 14 is a top view of the ionization system of FIG. 13;

FIG. 15 is a fragmentary isometric view of a support rod for the interior electrode of the ionization system of FIG. 13;

FIG. 16 is a schematic elevation view of an ionization system embodiment of the invention, using a number of ionization assemblies;

FIG. 17 is a fragmentary isometric view, partly in section, of a manifold of the ionization system of FIG. 16;

FIG. 18 is a front view of another embodiment of the ionization assembly, shown in an open case;

FIG. 19 is a back view of the open case of the ionization assembly of FIG. 18;

FIG. 20 is an isometric view of the ionization assembly of FIGS. 18 and 19, with the case closed;

FIG. 21 is a schematic illustration in elevation, partly shown in section, of an ionization system according to an embodiment of the invention;

FIG. 22 is a front view of another embodiment of the ionization assembly, shown in an open case; and

FIG. 23 is a sequential breakdown of the nitrogen ionization/deodorization process.

### DETAILED DESCRIPTION

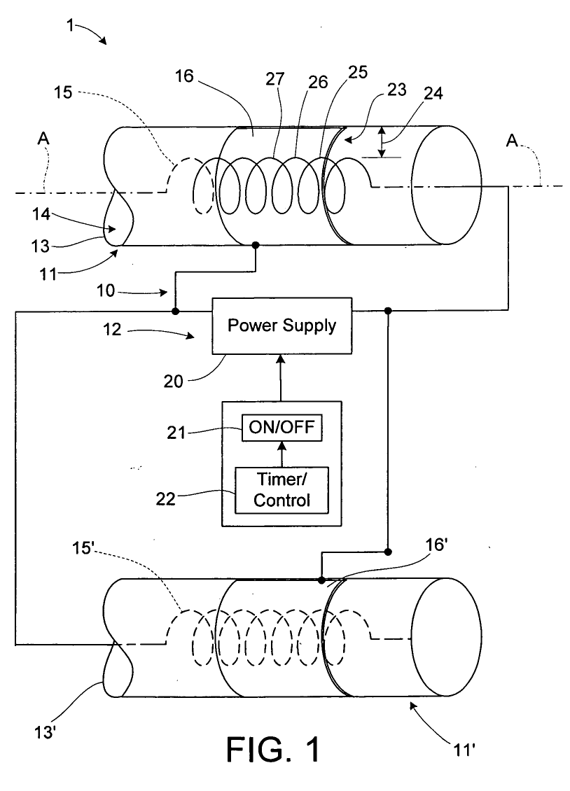

Referring now to the drawings, wherein like reference numerals designate like parts in the figures, and initially to FIG. 1, an electrical discharge device or system 1 employed as an ionizer 10 in accordance with the present invention is illustrated. The ionizer 10 includes an ionization assembly 11 and an electrical source or power supply 12. The ionization assembly 11 includes a tubular dielectric body or housing 13, which is referred to below additionally as an ionizer tube 13 or tube 13. The ionizer tube 13 may be cylindrical with a circular cross-section, or some other cross section and an elongate axis A (additionally referred to below as the “longitudinal axis”). In the embodiments described and illustrated, the axis A is straight or linear, but it will be appreciated that the axis A and, thus, the ionization assembly 11 may be other than straight or linear, e.g., curved or serpentine. The ionizer tube 13 has a hollow interior 14 so as to allow for a fluid to be contained therein and/or to flow therethrough. If desired, other components may be located in the interior 14, provided there is adequate space for fluid that is intended to be ionized and/or a flow of such fluid into and/or through the ionizer tube 13 while the fluid is being ionized.

The ionization assembly 11 also includes an interior electrode 15 and an exterior electrode 16. The interior electrode 15 is located in the interior 14 of the ionizer tube 13, and the exterior electrode 16 is located outside the ionizer tube 13. The interior electrode 15 is mounted with respect to the ionizer tube 13 or is otherwise mounted so that the electrodes 15, 16 are maintained in spaced-apart relation. The ionizer tube 13 is of dielectric material, such as glass, pyrex, quartz or some other material.

The electrical source 12 provides electrical energization of the electrodes 15, 16 using an AC type of signal or power or, if desired, a pulsed DC signal that may have an effect similar to that of an AC signal and in any event is suitable to operate the ionizer 10 in the manner described further below.

The electrical source 12 may include on/off controls, timer controls, transformers, and/or components that may be used to provide suitable electrical energization of the electrodes 15,16 in order to obtain ionization of fluid in the ionizer tube 13. Accordingly, the electrical source 12 is illustrated, by way of example, as including a power supply transformer 20 that is connectable to suitable utility company power lines, an on-off switch 21, and a timer control 22. The on-off switch 21 may be operated manually or by the timer control 22 to control delivery of power to and/or from the power supply transformer 20, for desired energization of the electrodes 15, 16.

In operation of the ionizer 10, AC electrical power is provided to the electrodes 15, 16 which create an electric field there between. A fluid is in the space 23 between the electrodes 15, 16, and the ionizer is intended to ionize the fluid or one or more of the constituents thereof. To simplify the discussion below, the fluid in the ionizer tube 13 and, in particular, in the space 23, is air, and the constituents of the air intended to be ionized are nitrogen and/or oxygen. However, it will be appreciated that the ionizer 10 may be used to ionize other materials; for example, fluids and/or constituents thereof. As will be appreciated from the description below, the ionizer 10 is useful for ionization of nitrogen and other gases which have a relatively higher ionization potential compared to that of oxygen.

In response to each half cycle of the AC power signal, the electric field between the interior and exterior electrodes 15, 16 builds, generally following the curve or shape of the AC power signal. When the potential difference between the electrodes is of a sufficient magnitude, an electric discharge is introduced by one of the electrodes into the fluid in the space 23. The potential difference at which the electric discharge occurs may depend upon the gap or spacing between the electrodes; as is schematically illustrated at 24 in FIG. 1. The ionization potential for oxygen is lower than the ionization potential for nitrogen. Therefore, if the gap 24 is relatively small and the potential difference at which the electric discharge occurs is relatively small, then oxygen in the air would be ionized and the ionized oxygen may create ozone. However, if the gap 24 is relatively larger so that the potential difference at which the electric discharge occurs is sufficiently large, the electric discharge may ionize at least some of the nitrogen constituent of the air in the space 23. Having the dielectric barrier in place prevents the electrons from reaching the exterior electrode. The electrons discharge from the interior electrode 15 and the electrons provided by such a discharge cause the desired ionization effect. Discharge from the interior electrode 15 into the air in the space 23 is preferential by comparison to the discharge from the exterior electrode 16 because the latter discharge must traverse the dielectric material of the ionizer tube 13 which results in an energy loss that heats the dielectric material.

In FIG. 1, the interior electrode 15 is illustrated as a wire 25 of electrically conductive material. Exemplary materials include copper, steel, stainless steel, aluminum, nickel, zinc, various alloys of the above and/or other materials, etc. Materials containing relatively high levels of nickel tend to reduce the possibility of corrosion or oxidation reactions. The wire 25 is coiled so as to have a number of loops 26. As is described below, the loops 26 of the wire 25 forming the interior electrode 15 may function as individual discharge sites from which electrons are discharged into the air in the space 23 between the electrodes 15,16. For example, a location 27 on a given loop 26 charges to accumulate electrons in response to energization by the electrical source 12 via the wire 25. The accumulation of charge or of electrons tends to be at a location of a given loop that is relatively closer to the exterior electrode 16 than other parts of the same loop. When the electric field in the space 23 in proximity to the given loop is sufficiently large, the electrons accumulated, or with which the given loop location 27 has charged, will discharge into the gas. Thus, such location is referred to below as a discharge site.

Since the several loops 26 are formed from the wire 25, which may be continuous from the first loop to the last one along the axial length of the ionizer tube 13 in the space 23, the respective discharge sites 27 tend to charge in electrical series in a manner similar to the way in which a number of electrical capacitors that are connected in electrical series would charge. However, as is described in greater detail below, the discharge sites 27 of the individual loops 26 tend to discharge somewhat independently of the discharge occurring at the discharge sites of other loops 26; thus, in a sense the discharge sites of the respective loops 26 tend to discharge in electrical parallel.

In an exemplary operation of ionizer 10, a number of advantages may be achieved. For example, balanced or substantially uniform charging of the individual discharge sites 27 is achieved due to the electrical series connection thereof; this helps to provide substantially uniform charging of each of the loops so that the discharge sites are approximately at the same potential during charging and the discharge sites will be ready to discharge into the air in the space 23 approximately at the same time. Also, since the loops 26 and the respective discharge sites 27 thereof discharge in parallel, the action of discharging electrons into the space 23 from one discharge site of one loop ordinarily would not tend to draw electrons from another discharge site of a different loop; this characteristic of the ionizer 10 helps to provide for substantially uniform discharge along the length of the interior electrode 15 in the space 23. Hotspots or concentrations of charge and, accordingly, discharges from a preferential discharge site along the interior electrode 15, are avoided, which also reduce the likelihood that the interior electrode 15 or the dielectric material of ionizer tube 13 would burn out at such a site.

Each loop of the coil is in effect a separate circuit. As a loop charges, it will continue to charge to a sufficiently high level and will act as its own individual discharge site. The loop does not react to the respective charging and discharging cycles at loops adjacent to it or the loop most distant from it. As long as the charging current continues to flow through the wire, the wire will continue to charge each individual coil circuit.

Still another advantage of the form and function of the ionizer 10 is the distribution of the discharges along the length of the interior electrode 15 in the space 23 so that the extent of discharge from each discharge site is self-limited to the electrons accumulated there and is substantially the same from each of the discharge sites in the space 23; this characteristic helps to avoid the possibility of the interior electrode 15 or the dielectric material of ionizer tube 13 becoming overloaded and/or burning out, and also helps to provide a substantially uniform ionization effect in the air in the space 23 and/or following there through.

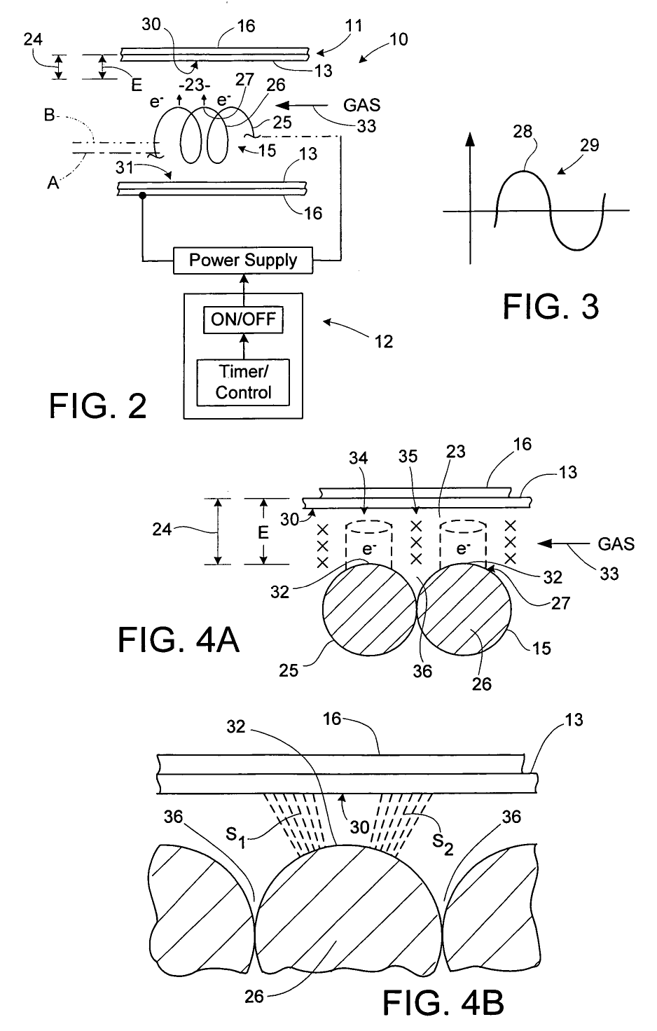

Turning briefly to FIG. 2, a fragmentary side elevation section view of the ionizer 10 is illustrated. During one half cycle 28 of the AC power signal 29 provided by the electrical source 12, as is illustrated schematically in FIG. 3, electrons accumulate or charge at the respective discharge sites 27 of respective loops 26 of the interior electrode 15. When the voltage of the electric field E in the gap 24 is of sufficient magnitude, electrons “e” discharge into the medium , e.g., air, in the space 23.

To facilitate describing the invention, unless otherwise expressed or evident, charging and discharging is described below for that portion of the AC input power signal during which electrical charge accumulates on the interior electrode and discharges into the air in the space 23 between the electrodes 15, 16. Operation in the opposite direction during the opposite polarity half cycle of the input AC power is treated separately below.

As is shown in FIG. 2, the interior electrode 15 includes a number of loops 26 about an axis B, which may or may not be parallel to or coincident with the ionizer tube 13 axis A. As shown, axes A and B are not coincident, and the interior electrode 15 is closer to the illustrated top 30 of the ionizer tube 13 than to the illustrated bottom of the ionizer tube 13. The directions top and bottom are for description purposes only and are not intended to be limiting. It may be difficult, if not impossible, to assure precise alignment of the interior electrode 15 relative to the ionizer tube 13 so as to obtain substantially equal spacing of all portions of respective loops 26 relative to the interior surface of the ionizer tube 13. However, since it is likely that the respective portions of the loops 26 will be closer to one surface or portion of the ionizer tube 13 than to another, as is illustrated in FIG. 2, those “closer” portions of the loops 26 are the respective discharge sites 27. Since those portions of the loops 26 that are relatively closer to the exterior electrode 16 tend to have the electrons accumulate during charging, such portions become the discharge sites 27. It is possible that the interior electrode 15 is somewhat non-uniformly located in the ionizer tube 13 so that several of the discharge sites are closer to the top 30 of the tube and several others are closer to the bottom 31 of the ionizer tube; this arrangement still will allow for proper operation of the ionizer 10 generally along the lines described above. It also is possible that the interior electrode 15 may be of another shape or construction than that illustrated in FIGS. 1 and 2; several additional shapes and constructions are described further below and are by way of example only.

Another schematic illustration of a part of the ionization assembly 11 is shown in FIG. 4A. In FIG. 4A the interior electrode 15 is formed of a wire 25 that has a number of loops 26 that touch each other. The interior electrode 15 shown in FIG. 4A may be, for example, a coil spring in which each of the loops 26 is formed by a respective coil of the spring. An exemplary coil spring may be the type that includes a number of coils that are wound in a helical manner generally circumferentially about a central axis such as axis B illustrated in FIG. 2.

As is shown in FIG. 4A, the wire 25 from which the interior electrode 15 is formed is approximately circular in cross-section. Whether the wire is circular or other than circular, is not necessarily critical. However, it is advantageous for the surface 32 of the wire in the area of the respective discharge sites 27 to be curved. Such curvature of the cross-section as is illustrated in FIG. 4A and the curvature of the respective loops or coils 26 tends to de-stress the electrode 15 preparatory for electrical charging and discharging.

De-stressing relates to the profile of the electrode and creates instability in the firing of the discharge such that the discharge will not always fire at one localized high stress point. As the cross-section or diameter of the coil wire increases, the profile is improved. The profile could improve further if the coil electrode was not perfectly round. If the electrode wire had an ellipsoid shape with the flatter side facing into the field, the profile could be optimized. This design change, however, would require specially drawn electrode wire. A reasonable low-cost design alternative is employed by sizing the wire correctly and using of round wire.

In effect, destressing encourages the charge to accumulate at random points during each cycle rather than at a single point every time. Accordingly, discharge does not occur only at a single point. Rather, the charge accumulates over an area of each respective loop of the coil 26, that area being in relatively close proximity to the exterior electrode 16 as compared to portions of a given coil on the diametrically opposed side of the coil relative to the coil axis B. Thus, the discharge of electrons from their respective discharge sites 27 into the air in the space 23 occurs not from a single point, but rather from the mentioned area of the particular coil 26 where the charge had accumulated. Therefore, the actual discharge location may move to various places in the general area during discharging. Since discharge occurs periodically or cyclically each time the magnitude of the AC electric field E is sufficiently great, the discharge into the air in the space 23 is initiated, and then it ceases until the next half cycle of the AC input power occurs. Excessive accumulation of electrons and discharges that otherwise might cause a hot spot, excessive heat, and/or burning-out of the interior electrode 15 or a portion of the tube 13, would not ordinarily occur. Moreover, since electrons will not normally move from one loop of the coil to an adjacent loop, i.e., from one discharge site to the discharge site of an adjacent loop, the magnitude of discharge that occurs at relatively adjacent discharge sites will be approximately the same, thus avoiding stressing of the respective discharge sites and/or portions of the interior electrode 15.

In general, a reduction in heat at the discharge locations reduces deteriorization of the electrode 15 and the dielectric tube 13. By in a sense allowing separate discharge at respective loops of the coil electrode and by allowing the arc to move randomly at a loop, a distributed capacitance occurs because there are unequal distances between the discharge sites 27 and the exterior electrode 16. If the loop 26 is off center, it is going to fire at its closest point to the exterior electrode 16. The firing may move in a screw-like fashion within the tube 13, and in that case it is possible that the loop 26 itself may move laterally in the tube. Such movement operates to further randomize the firing location and the dispersion of the electrons into gas or other medium in the tube.

As is illustrated in FIG. 4A, when the respective discharge sites 27 of loops 26 of the interior electrode 15 discharge into air flowing in the direction of the arrow 33, electron clouds 34 tend to move into the flowing gas. The electron clouds are illustrated as moving from respective discharge sites toward the wall of the ionizer tube 13 and exterior electrode 16; the actual shape of the electron clouds is not precisely known and is not material to this description. The electrons in the respective electron clouds 34 tend to ionize the constituents of the air in the area of those electron clouds. Some of the air in the area 35 between respective electron clouds may be non-ionized; however, as the air flows in the direction of the arrow 33, the non-ionized air will move into an area where there is an electron cloud 34 and will tend to become ionized.

The actual discharge of electrons into the air in the space 23 by respective discharge sites 27 may occur simultaneously for a number of discharge sites or may occur at separate times. However, the electrical output from the AC electrical source 12 may be selected so as to assure that all discharge sites 27 are adequately charged in each half cycle so that they do, in fact, discharge. In some instances, it is possible that a discharge that is initiated at one discharge site may tend to excite, to trigger, to help excite or to help trigger a discharge at another discharge site, such as at an adjacent discharge site. It also is possible that ultraviolet emissions may occur during a discharge at a given discharge site 27; such ultraviolet emission may encourage or tend to trigger a discharge at another, for example, adjacent, discharge site.

During the just described electrical discharges that occur from respective loops 26 into the air in the space 23, the actual location on the electrode 15, and more particularly on the given loop 26 of the electrode, where the discharge occurs may change during the course of the discharge due to changes in air flow rate, air pressure, the ionization of air, the flow of non-ionized air into the region of a given electron cloud, etc. In the illustrated embodiment, the discharge area is curved in two directions, one curve being the curvature about the circumference or an arc portion of the circumference of a cross-section of the electrode as viewed in, for example, FIG. 4A and the other curve being the general curvature of the loop 26, e.g., a curved loop portion of a spring, which is composed of a number of adjacent loops, for example. The unique and random movement of the actual location of the discharge into the air tends to de-stress the electrode 15, as is mentioned above.

The discharge is illustrated as a electron spray off the coil wire 26, as is shown in FIG. 4B. Although the electron charge and sprays S₁ and S₂ can follow the wire longitudinally or around its coil, the longitudinal movement of the charge is very small. In other words, the electron spray S₁, S₂ off the coil wire 26 does not move down the tube 13. The electron spray generally originates from the apex or crown 32 of the wire 26 and its ability to jump from different portions of the crown 32 of the wire 26 due to its instability is one of the factors that prevents damage to both the electrode wire 26 and the dielectric tube 13.

During charging of the electrode 15 in a given half cycle of electrical power from the electrical source 12, as is mentioned above, each of the discharge sites 27 on respective loops 26 tends to accumulate charge at the exterior surface area 32 thereof that is in relatively closest proximity to the exterior electrode 16 relative to the exterior surface of another portion of the given loop 26. The charge that has accumulated at a given discharge site tends to stay at that area 32 and tends not to move or to drop into the valley area 36 that is between the respective pairs of loops 26 and the associated discharge sites 27 thereof. The electrical field between the interior and exterior electrodes 15, 16 tends to draw electrons of the respective loops 26 toward the exterior electrode 16 and, therefore, tends to impede transfer of electrodes 15, 16 into the valley area 36. Therefore, although the discharge site 27 of a given loop 26 may have commenced discharging into the air in the space 23 before the discharge site 27 of an adjacent loop 26 has begun discharging, charge will tend not to conduct from the latter loop 26 to the former loop 26. Ordinarily, energy would be required to move the electrons from the discharge site 27 of one loop 26 into the valley area 36 for conduction to an adjacent loop 26; but there is no energy provided for such movement. Further, due to the somewhat offset or off-center positioning of the interior electrode 15 relative to the ionizer tube 13 and exterior electrode 16, as is described above, the charge will tend not to migrate around a given coil or loop 26 to an adjacent loop 26. Therefore, each loop 26 tends to act as a separate circuit during the discharge phase of operation. In a sense, then, each loop 26 tends to discharge electrons from the respective discharge site 27 thereof into the air in the space 23 separately from the other loops 26 and discharge sites 27 in a manner similar to the parallel discharge of a number of capacitors.

The precise dimension or gage of the wire 25 forming the interior electrode 15 is selected from a wide range of values. The gage should be adequately large so that there is a sufficient difference in electrical potential between the discharge sites 27 and the respective adjacent valleys 36 in order to preclude charge at the discharge 27 site of one loop 26 conducting into a valley for transfer to an adjacent loop 26. Other examples of such devices and electrodes can be found in pending U.S. patent application Ser. No. 10/046,569 filed on Jan. 10, 2002 titled Corona Generator, Reactor and Method, incorporated herein by reference.

It usually takes greater energy to create ionized nitrogen than ionized oxygen. Compared to ozone that tends to clump after it is formed lose effectiveness as a deodorant, ionized nitrogen and oxides thereof usually does not clump and can operate much more effectively and provide greater deodorization than ozone for the same energy input, e.g., by being better able to enter small cracks, crevices and the like, which can block ozone entry.

To achieve a higher energy state, the ionizer 10 operates with a wider gap and higher voltage than an ozone generator, normally to the detriment of the dielectric tube's 13 life. A standard ionizer produces a hotspot if the ionizer does not control the discharge so that the arcs have a limited amount of amperage for arcing and, therefore, a limited amount of heat in that vicinity.

Destabilization of the individual discharges in the ionizer of the invention operates to ensure hotspots are avoided even with the use of larger gaps and higher voltages than ozone generators.

This distributed capacitance can be achieved with a tube 13 having an exterior electrode 16 coating such as a coating, a piece of aluminum tape, or any conductive film. Inside that electrode is a steel rod (with or without threads) and a coiled wire or spring installed over the surface of the rod. The coiled wire has a surface which not only distributes the capacitance, but also makes the discharge location unstable and moves it around.

The present invention is useful for ionization of fluid. If the gap 24 between the discharge sites 27 of the interior electrode 15 and the exterior electrode 16 is sufficiently small so that the potential difference that exists when electric discharge occurs is relatively small, primarily oxygen would be ionized, but little nitrogen. However, if the dimension of the gap 24 were increased, the potential difference at which electric discharge occurs would be made large enough to ionize more nitrogen.

There is a relationship between the gap 24 from the loop 26 to the exterior electrode 16 and the diameter of the wire 25. If the diameter of the wire 25 is small in comparison to the gap 24 between the exterior electrode 16 and the loop 26, the exterior electrode 16 views the interior electrode loop 26 as nothing more than a point source. There should be a significant difference or large enough diameter of the wire 25 so that there are peaks 32 and valleys 36 that can be “seen” by the field electrode. If the diameter of the wire 25 is sufficiently large, from the electrons point of view the top surface 32 of the loop 26 looks somewhat like a planar surface and that planar surface increases the instability of the electron spray such that the electron spray tends to move a great deal. For example, FIG. 4B shows two electron sprays, S₁ and S₂, firing from different locations on top surface 32. The instability also tends to create a broader spray. This substantial movement across and around the top surface 32 causes the discharge to dance back and forth over the face of the dielectric material 30 and to increase the area or volume of gas into which electrons are provided. Such movement is confirmed by visual observation.

The design tends to randomize where the triggering, firing, or spraying of electrons occurs. The spray S₁, S₂ is randomized over each loop 26, and over all of the loops as they fire down the length of the device 10 when charged properly. For this application, it is not critical that the loops fire in any particular sequence.

While localized movement of the electron spray S₁, S₂ is encouraged, it is not advantageous for the electron spray S₁, S₂ to move longitudinally along loops 26 to the end of the field, or end of the tube 13. As explained above, in order to prevent jumping of the electron spray S₁, S₂ to the end of the tube 13, the selection of the coil electrode with pre-designed potential wells acts as a series of separate capacitor systems. With such a design, the arcs remain self-contained within their own loop's 26 field.

In the present invention, the dielectric material usually will not burn off because the amount of charge available to fire at the spot of the apex 32 of the coil that is closest to the outer electrode (field electrode) is self-limited by the charge stored in one loop 26 of the coil electrode 15. Electrons will not flow from a low-potential region of a loop 26 to a high-potential region near a discharge point 27 and then back through a low-potential region in order to get to a high-potential region of another loop 26. Indeed, any drawing of electrons from adjacent loops 26 is deminimis. In this manner, a distributed capacitance is created for the system. Additionally, with the larger diameter of the coil wire as an electrode, the discharge is not only limited by the amount of charge in that single loop 26, it is also an unstable arc because of the surface shape of the electrode 15. Such an arc moves around not only laterally, but longitudinally, and is very unstable.

Locally, hotspots may reach 1000 degrees Fahrenheit. Even simple glass will tolerate that temperature for a period of time as long, as the hotspot does not always occur in the identical spot. If the electron spray moves around, it may strengthen the local region of the dialectic material in somewhat of an annealing fashion.

In an exemplary embodiment, the arc gaps 24 shown in FIG. 1 may be approximately in the range between 1/16 to ½ inch total. The total gap is the actual distance between the inner electrode's 15 outer surface and the outer electrode's 16 inner surface, which includes the dielectric barrier, tube 13. In prior ozone generators, smaller gaps are common and may be used specifically to prevent the ionization of nitrogen.

In an exemplary embodiment of the invention, the gap size 24 is sufficiently large to provide for ionizing nitrogen by the ionizer 10. Looking in detail at the circuit disclosed in FIG. 1, the line voltage is provided by an AC electrical source 12. A timer 22 controls the energization of the fan, indicator light and primary power supply 20. The primary power supply 20 then provides AC power to the two banks of reactor tubes. One bank of tubes indicated by the ionization assembly 11 receives the AC power in one polarity and the other bank indicated by ionization assembly 11′ receives power in the opposite polarity, so that when using common 60 Hz AC power, the apparatus discharges 120 times per second. In one embodiment, the power supply 20 is a standard neon sign transformer.

In an exemplary embodiment, the power supply 20 operates at 9,000 volts on the secondary winding with a 30 milliamp current. It is, however, possible to utilize alternative power supplies in combination with an alternative reactor tube configurations to produce the desired ionized nitrogen.

Exemplary construction details include a ⅝ inch OD tube with a ⅜ inch OD coil wrapped around a center rod. The resulting configuration yields an actual gap between the counter electrode and the inner electrode of ⅛ inch. Tube thickness is approximately 0.06 inches, and the air gap spacing is approximately 1/16 inch. Such an example construction has been operated from 5,500 to about 15,000 volts. An advantage of going to a higher voltage is that the length of the discharge pulse is extended and the ionization output is increased.

Interior Electrode

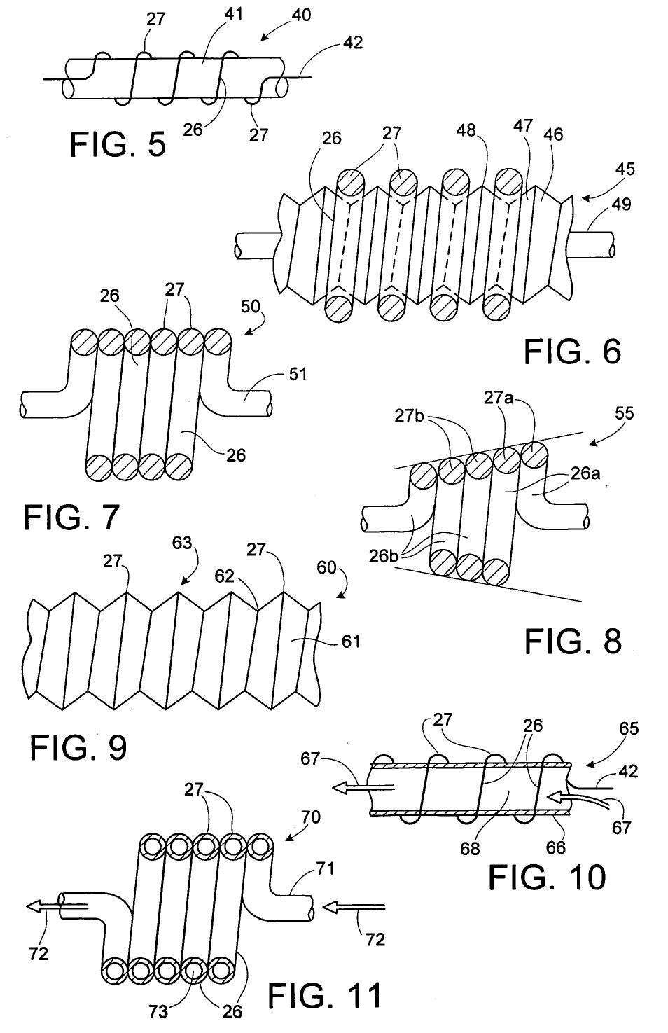

Several alternative embodiments of interior electrodes are illustrated in FIGS. 5-9. These interior electrodes and the interior electrode 15 illustrated in FIG. 1 are exemplary and, with adaptation, may be used in the ionizer 10 of the electric discharge device 1 to achieve the operations described herein and/or other operations. It will be appreciated that other equivalent forms of interior electrodes may also be used in the present invention.

The interior electrode 40 in FIG. 5 includes a support 41 and a conductor 42. The conductor 42 may be a wire, for example, that is wrapped around the support 41 so as to have a number of loops 26. The wire 42 may be wrapped tightly or loosely about the support 41. The loops 46 may be equally or unequally spaced along the support 41. Equal spacing tends to contribute to the substantial uniformity of charging and discharging operation in an ionization assembly 11 that includes the interior electrode 40. The loops 46 may engage each other as in FIG. 4A or may be spaced apart as in FIG. 5. The support 41 may be a conductive material, such as a metal rod, or may be a non-conductive material, such as glass, plastic or some other material. If the support 41 is electrically conductive, then it may contribute to the charging of the respective loops 26 and associated discharge sites 27 thereof. In that event, the current flow to the coil is through the rod, the rod itself providing the electrons for discharge.

In FIG. 5, one of the discharge sites 27 is shown at the bottom of the interior electrode 40 and one of the discharge sites 27 is shown at the top; this illustration is representative of the interior electrode 40 being in a ionizer tube 13 (FIG. 1) oriented non-parallel to the axis A of the ionizer tube 13, indicating the different possible locations of discharge sites depending on proximity to the exterior electrode 16. It will be appreciated from this illustration and description that the various interior electrodes disclosed herein may be oriented either parallel, substantially parallel or non-parallel to the axis A of the ionizer tube 13.

In FIG. 6, another embodiment of the interior electrode 45 is illustrated. The interior electrode 45 includes a support 46 in the form of a threaded rod that has a main body 47, and a thread 48 in the main body. The interior electrode 45 also has a wire 49 that is wrapped around the threaded rod in the respective grooves of the thread 48. The thread 48 may be a conventional thread, such that a nut may be attached to the threaded rod. Accordingly, the thread may be helical or some other shape and may extend over only a portion of the axial length of the rod 46 or along the entire length thereof. The pitch of the thread may be selected for the desired spacing of the respective loops 26 of the wire 49. Having the wire 49 wrapped in the thread facilitates the maintenance of uniform spacing of the respective loops and the respective discharge sites 27 thereof. The depth and/or shape of the thread 48 may be coordinated with the gage of the wire 49 so that the above-described isolation of respective discharge sites 27 is maintained so as to avoid leaking or conducting of charge from one discharge site to an adjacent one, for example. Thus, in an exemplary embodiment, the gage of the wire 49 is sufficiently large to assure the discharge sites 27 are above the largest diameter circumferential plane of the threaded rod as defined at the respective peaks between recessed threads of the rod. If desired, other provisions may be made to assure non-conducting of charge from one discharge site to an adjacent one. In the illustrated embodiment, the peaks of the respective threads should be sufficiently below the discharge sites 27 of the respective loops 26 of the wire 49 to avoid or to reduce the likelihood of unintentional electrical discharges directly from the threaded rod into the air in the space 23 of the ionizer tube 13.

The threaded rod 46 may be of an electrically conductive material, such as stainless steel, copper, aluminum, or some other conductive material. If the threaded rod 46 is electrically conductive, then it may be used to conduct current in order to assist in charging the discharge sites 27. In such a case, charging of the discharge sites 27 may be by conduction through the wire 49 and/or through the threaded rod 46. Alternatively, the threaded rod 46 may be electrically non-conductive or may have a coating of electrically non-conductive material on it, and, in such a case, the charging of the discharge sites 27 would be via the wire 49 without participation from the threaded rod 46.

The interior electrodes 40, 45 may have the wire 42, 49 simply wrapped to the respective support 41, 46. If desired, additional means may be used to retain the wire 42, 49 to the support 41, 46. For example, adhesive material may be used. Another example may include a mechanical connection by soldering, riveting, welding, etc. Another possibility is to use a nut or friction holding fastener that is attached to the support and retained thereon while also retaining the wire relative to the support. These are but a few examples, and other means also may be used.

Briefly referring to FIG. 7, another embodiment of interior electrode 50 is illustrated. The interior electrode 50 is a coil spring type of device that is self-supporting. The coil spring is electrically conductive, having at least one end 51 that is connectable to receive electrical input from the electrical source 12. Supports, fasteners and the like (not shown) may be used to mount the interior electrode 50 in or with respect to the ionizer tube 13 of the ionizer assembly 11 (FIG. 1). The coil spring interior electrode 50 includes a number coils or loops 26 and respective discharge sites 27.

FIG. 8 illustrates another embodiment of the interior electrode 55. The interior electrode 55 is a coil spring similar to the interior electrode 50 except that the coils are of progressively narrower diameter, moving from right to left in the illustration, thus forming a truncated, conical shape. Although the truncated, conical shape is shown embodied in a self-standing coil spring configuration of the interior electrode, it will be appreciated that other embodiments of the interior electrode also may be provided in a truncated, conical shape. Some of the coils 26a and associated discharge sites 27a of a truncated, conical shape interior electrode, such as the electrode 55 shown in FIG. 8, ordinarily would be positioned in the ionizer tube 13 closer to the exterior electrode 15 than the other coils 26b and the associated discharge sites 27b. In use of an ionization assembly 11 with a truncated, conical shape or other tapered shape interior electrode 55, the discharge sites 27a that are closer to the exterior electrode 16 usually would begin to discharge into the air in the space 23 sooner than the discharged sites 27b. The result of this action can be the emission of ultraviolet light/radiation by the first discharges so as to assist or to induce discharges from the discharge sites 27b that are further away from the exterior electrode 16. Such operation tends to result in a sequence of discharges that may be designed to cause a pumping and/or mixing of the air in the ionizer tube 13.

Another embodiment of the interior electrode 60 is illustrated in FIG. 9. The interior electrode 60 takes the form of a solid electrically conductive rod 61 that has a number of discharge sites 27. No separate wire is used for the interior electrode 60. The rod is threaded in order to provide raised discharge sites 27 relative to the troughs 62 of the respective threads 63. The thread may be formed as a helical thread or may be some other configuration. Preferably the discharge sites are not sharp points, but take on a somewhat smooth or curved shape so as to avoid point discharges and to achieve the advantages of De-stressing the discharge sites 27 as was described above.

Threaded rods without a separate coil electrode can present problems relating to the life of the dielectric material. If the threads are not completely smooth, any sharp points or localized raised points may cause the device to discharge solely off those points, and the electron spray will not move around as readily as off of a coiled wire electrode. Accordingly, the threaded rods do not produce as unstable an arc as would a coiled wire.

FIG. 10 illustrates another example of the interior electrode 65. The electrode 65 is formed from a hollow tube 66, about which is wrapped or otherwise located a wire 42. The wire 42 functions similarly to the wires or coils described above. The tube 66 may be made of an electrically conductive material, for example, copper, aluminum, stainless steel or some other electrically conductive material; and in such cases the tube may participate in charging the respective coils 26 and discharge sites 27 of the wire 42, as is described above. Alternatively, the tube 66 may be of an electrically non-conductive material, such as, for example, glass, PYREX, quartz, plastic or some other suitable material having appropriate dielectric properties and heat-resisting properties. A cooling fluid designated by the arrow 67 may be directed to flow through the hollow interior 68 of the tube 66 so as to provide cooling for the tube and/or the wire 42.

Another fluid-conducting interior electrode 70 is illustrated in FIG. 11. The electrode 70 is formed of a hollow fluid-conducting tube 71 that is in a coil shape having a number of loops 26 and discharge sites 27 analogous to the various loops and discharge sites described above. A fluid coolant 72 may be directed to flow through the interior 73 of the coil tubular interior electrode 70 so as to cool the interior electrode during operation in an ionizer assembly 11.

Each of the interior electrodes described above and illustrated in the drawings and other similar or equivalent interior electrodes may be used in an ionization assembly 11 of an ionizer 10 as is described above in order to provide an electric discharge into a fluid, such as air, in the ionizer tube 13. Moreover, it will be appreciated that features of any of the above electrodes also may be used in combination with features of one or more of the other electrodes described above in accordance with the present invention.

Exterior Electrode

The exterior electrode 16 illustrated in FIG. 1 is a conductive material. An example of such a conductive material may be an electrically-conductive tape. Another example is an electrically-conductive coating, cladding, or a metal strip that is wrapped about or otherwise placed about the dielectric housing material of the ionizer tube 13.

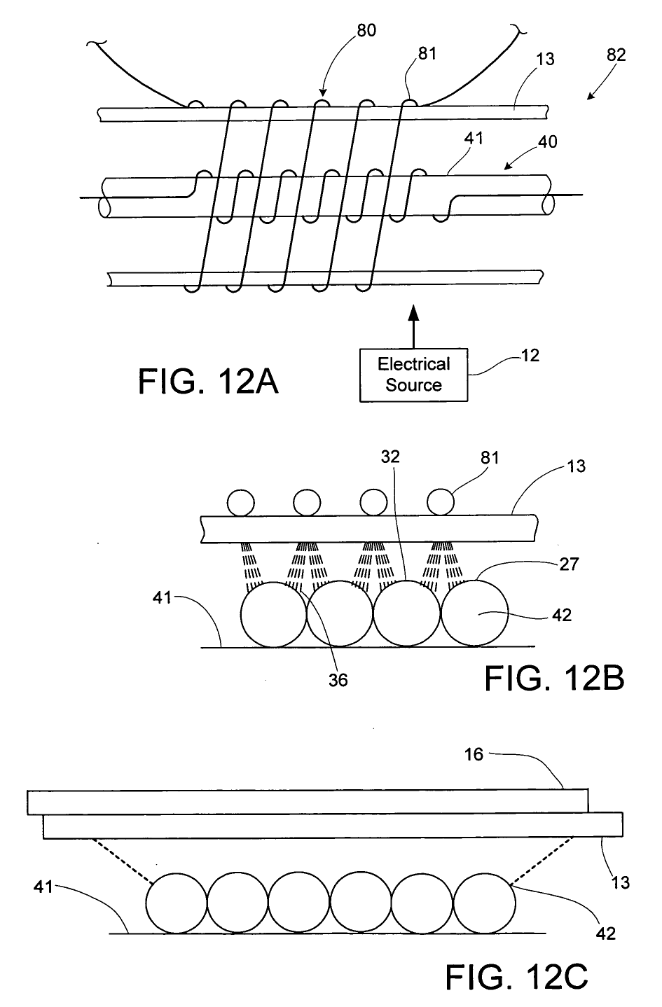

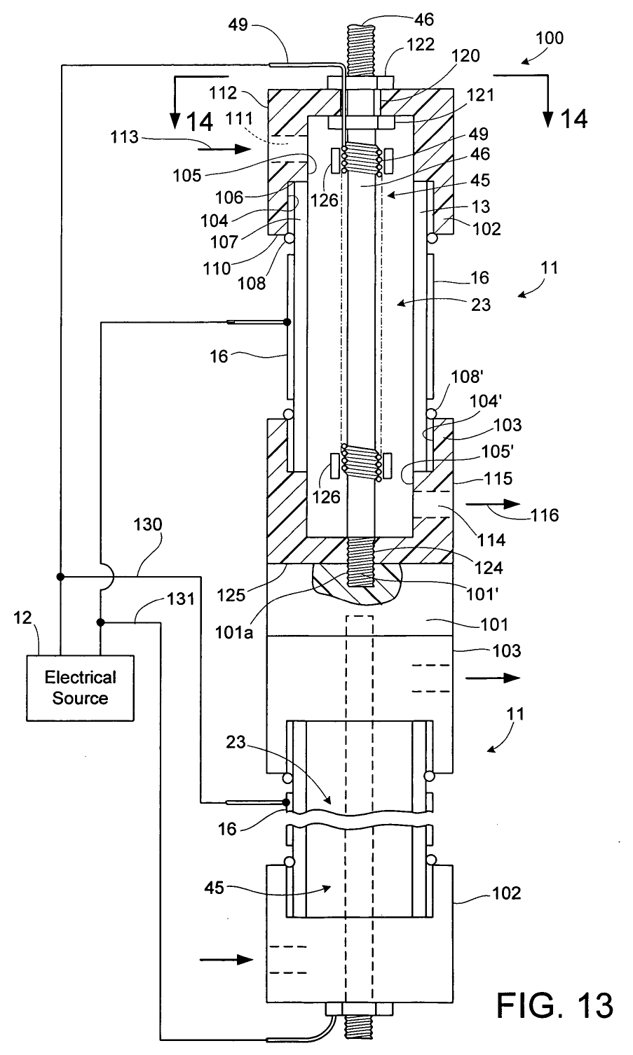

Another embodiment of the exterior electrode 80 is illustrated in FIG. 12A in the form of a wire 81 that is wrapped around or otherwise positioned around, coiled around, etc. an ionizer tube 13. An ionizer 82, which includes the ionizer tube 13 with the coil form of the exterior electrode 80 and the interior electrode 40 is illustrated in FIG. 12A. The interior electrode may be one of the types of electrodes described above. Operation of the ionizer 82 is similar to the operation described above for the ionizer 10, for example.

The exterior electrode can also be used as a steering electrode. For example, if the exterior electrode is discontinuous, such as wire 81, when the interior electrode 40 discharges, the discharge will tend to roll toward the nearest points on the exterior electrode 80. This external electrode may be a spiral, provided that it is discontinuous.

Another purpose for a discontinuous field electrode is that there are significant areas of non-ionized gas in the valleys 36 of the interior electrode 42. See FIG. 12B. If the electron sprays off the interior electrode can be directed, they can be used to promote more mixing in the areas of non-ionized gas. One approach to achieve this result is to arrange the exterior electrode such that it is not directly opposite the apex 32 of the interior coil wire 42. In other words, by placing a spiral wire 81 on the outside of the dielectric tube 13, the electrical field generated would correspond to the valleys 36, not to the apexes 32, such that the design would draw the discharge into the valleys 36 and ionize the gas therein.

The steering effect can have a dramatic effect at the termination of the exterior electrode, as shown in FIG. 12C. It is recommended that the exterior electrode 16 be made longer then the interior electrode 15. This design serves to keep the discharge within the width of the exterior electrode. The overlapping edge “steers” the discharge within the unit. Building the unit another way with the exterior electrode being shorter than the coil, may result in a charge build up on the exterior electrode 16 that could arc across the outer surface of the dielectric material. The longer exterior electrode 16 operates so as to minimize any spurious arcing and thereby add to the unit's life.

Another design feature of the invention that encourages mixing of the ionized gases relates to a coil wire sized so as to create turbulence within the open airspace through which the fluid passes. For example, when the diameter of the wire is designed relative to the width of the fluid flow path, large undulations in the surface formed by the adjacent coils of the wire can promote turbulence in the airflow. However, if the coil wire has a relatively small diameter compared to the open airspace, the wire may act like a relatively smooth surface and will tend to promote a boundary layer with reduced turbulence and would, therefore, reduce the mixing affect.

Turning to FIG. 13, an ionizer system 100 is illustrated. The ionizer system 100 includes a pair of ionization assemblies 11, in which the interior electrodes 45 are of the type illustrated in FIG. 6 and which include a threaded rod 46 and a wire 49 wrapped in the thread thereof. The two ionization assemblies 11 of the ionizer system 100 may be the same; in the drawing, one ionization assembly is shown in greater detail than the other for convenience of illustration. The two ionization assemblies 11 are mounted to a dielectric barrier 101. Such mounting may be achieved by threaded or other mechanical connection; as an example, the threaded ends of rods 46 are secured in the threaded recesses 101a of the dielectric barrier 101. Such a connection may be achieved by adhesive material or by some other mechanical or other means. The two ionization assemblies 11 are not electrically connected through the dielectric barrier 101; rather, the dielectric barrier provides electrical isolation between the two ionization assembles.

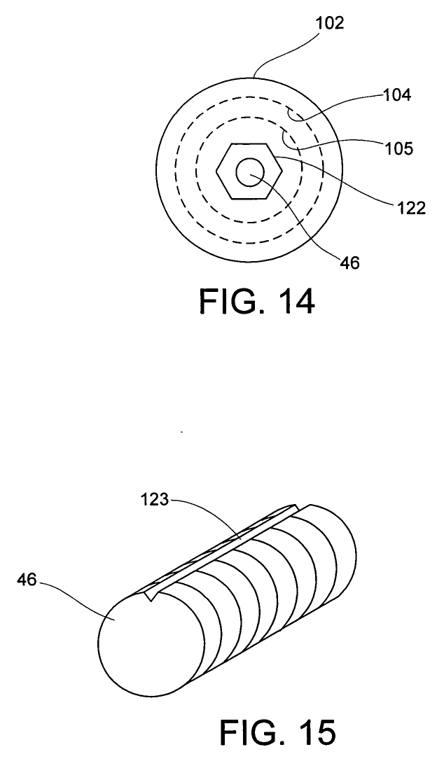

Referring now to the ionization assembly 11 at the top of FIG. 13, such an assembly 11 includes the interior electrode 45, a tubular dielectric body or ionizer tube 13, and an exterior electrode 16. The interior electrode 45 is mounted to a pair of dielectric end caps or housing members 102,103. Each of the end caps 102, 103 may be similar. In FIG. 14, a top view of the end cap 102 is illustrated. The end cap 102 has stepped, generally cylindrical interior walls 104,105, which meet at a step 106. The diameter and shape of the wall 104 is similar to the exterior diameter and shape of a portion 107 of the ionizer tube 13 such that the two tend to fit together in relatively close proximity. A seal 108 may be provided at a junction area of the ionizer tube 13 and an end 110 of the end cap 102; the seal 108 tends to prevent fluid, such as air, that is inside the ionizer tube 13 from leaking out from the ionization assembly 11. The seal 108 can be an adhesive material, an o-ring, or some other type of device that prevents fluid passage and also retains the end cap 102 and ionizer tube 13 together as a unit. An opening 111 in a side wall 112 of the end cap 102 provides an entry for air 113 to flow into the ionization assembly 11. The air may flow through the ionization assembly 11 to the space 23 between the interior and exterior electrodes, where ionization may occur. An opening 114 in the side wall 115 of the end cap 103 provides an exit path for the air 113 and any ionized species or constituent 116 of the air 113. The end cap 103 also includes stepped walls 104′, 105′ and a seal 108′ which provide functions similar to those described above with respect to the elements 104,105, and 108 by retaining the end cap 103 and the ionizer tube 13 in relatively fixed sealed relation to each other.

The interior electrode 45 is mounted to the end caps 102, 103 by threaded connections. The threaded rod 46 passes through an opening 120 in the end face of the end cap 102, and a pair of nuts 121, 122 secure the threaded rod to the end cap 102. A shallow groove 123 (FIG. 15) in the threaded rod 46 provides an unimpeded path for the wire 49 to pass through the opening 120 and to avoid being damaged by the nuts 121, 122. The threaded rod 46 is connected to the end cap 103 at a threaded opening 124 in the end wall or face 125 of the end cap 103. A metal band 126 or other means (e.g., a suitable plastic or ceramic band or adhesive) near each end of the rod 46 may be used to hold the wire 49 to the rod 46.

As is mentioned above, the ionization assembly 11 at the bottom of FIG. 13 may be the same as the ionization assembly 11 at the top of FIG. 13 with the exception that the parts are in reverse order, whereby the end cap 102 is at the bottom and the end cap 103 is at the top of the lower ionization assembly 11.

The electrical source 12 is connected in reverse polarity relation to the two ionization assemblies 11, providing a bi-polarization type of ionizer system 100. One output terminal 130 of the electrical source is connected to the interior electrode 45 of the top ionization assembly 11 and to the exterior electrode 16 of the lower ionization assembly 11. The other output terminal 131 of the electrical source is coupled to the exterior electrode 16 of the upper ionization assembly 11 and to the interior electrode 45 of the lower ionization assembly 11. Therefore, it will be appreciated that when the upper interior electrode is positive relative to the upper exterior electrode, the lower interior electrode will be negative relative to the lower exterior electrode.

For purposes of this discussion, it will be understood that when the interior electrode is positive relative to the associated exterior electrode of an ionization assembly 11 (during one half cycle of the input power from the electrical power source 12), the interior electrode charges and eventually discharges to ionize the air in the space 23. In the opposite polarity half cycle of electrical energization of a given ionization assembly 11, when the exterior electrode 16 is positive relative to the interior electrode 45, there may be a tendency for the exterior electrode to charge and then to discharge electrons through the ionizer tube 13 to the air in the space 23. However, such charging and discharging encounters a relatively high impedance characteristic due to the dielectric material of which the ionizer tube 13 is made. In contrast, during such opposite polarity half cycle of AC electrical power from the electrical source 12, in the lower ionization assembly 11 the interior electrode may charge and then may discharge into air in the space 23 thereof via a much lower impedance path. Current flow would tend to follow the lower impedance path and, therefore, would tend not to charge the exterior electrode 16 of the upper ionization assembly 11.

With the above operational description in mind, then, it will be understood that while one ionization assembly 11 is charging and discharging in a so-called positive half cycle of electrical power from the electrical source 12, the other ionization assembly is acting, in effect, as a reverse-biased diode and conducts relatively little, if any, current. In the following half cycle, the roles of the two ionization assemblies 11 are reversed, whereby the one that had been non-conducting becomes conducting to charge the interior electrode and then to provide for discharge therefrom into the air in the space of that ionization assembly, while the previously charged and discharged ionization assembly acts as a reverse-biased diode.

As was mentioned above, the discharging of the exterior electrode 16 through the dielectric body of the ionizer tube 13 is a relatively inefficient process by comparison to the discharging of the interior electrode 45 directly into the space 23. The providing of a preferential, relatively efficient use of the respective half cycles of the electrical energy from the electrical source 12 so that little or no discharging occurs by an exterior electrode 16 through the dielectric material of an ionization tube, the ionizer system 100 operates with good efficiency and tends to reduce losses, such as losses that heat the dielectric material of the ionizer tube 13 on account of discharging by the exterior electrode 16 there through. Accordingly, electric energy from the electrical source 12 is used more efficiently in the bi-polarization system 100 of FIG. 13 than in a system that uses only a single ionization assembly 11. Moreover, since heat is not generated by electron transfer through the dielectric material of the ionizer tube 13 during one half cycle of electrical energy supplied by the electrical source 12, the ionization assemblies 11 of the ionizer system 100 tend to run cooler or to operate cooler than a single ionization assembly operating on both half cycles of the electrical source 12.

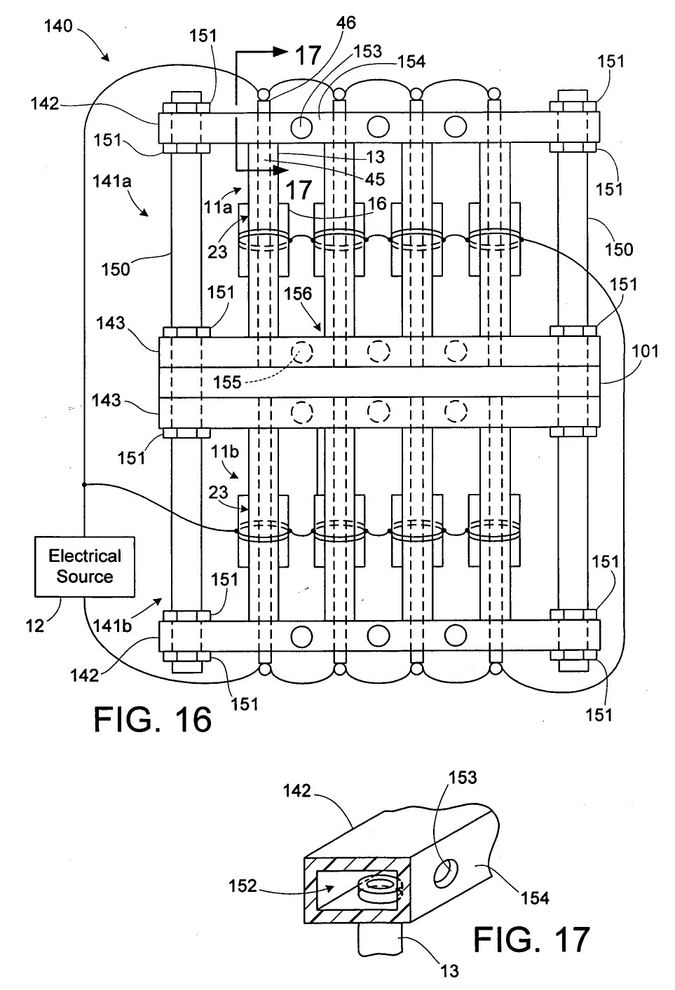

Another ionizer system 140 is illustrated in FIG. 16. The ionization assembly 140 includes four sets of bi-polar ionizer systems 100, each including a pair of ionizer assemblies 11a, 11b, for example, as is described above with respect to FIGS. 13-15. The ionization assembly 140 includes an upper bank of ionizer tubes 141a and a lower bank of ionizer tubes 141b. The two banks of ionizer tubes are arranged in respective pairs to balance use of the two half cycles of the AC electrical power provided by the electrical source 12. In the ionizer system 140, a pair of dielectric manifolds 142, 143 are used in place of the end caps 102, 103 described above with respect to FIGS. 13 and 14. Each manifold may be made of molded plastic, fiberglass, or of some other material. Additionally, each manifold 142, 143 has stepped walls to mount the ionization tubes 13 and openings and/or threaded passages for mounting the interior electrodes 45. A dielectric barrier 101 is located between the upper and lower banks of the ionization tubes 11a, 11b. The manifolds 142, 143, the dielectric barrier 101 and the ionization tubes 11a, 11b are secured together by mounting rods 150 and nuts 151. The mounting rods 150 may be of metal or plastic material of suitable strength to maintain the structure of the ionization system 140 securely and integrally generally in the manner illustrated in FIG. 16.

The threaded rod 46 of the interior electrode 45 may be attached to the respective manifolds 142,143 in the manner similar to the way in which the threaded rod 46 is attached to the end caps 102, 103 in FIG. 13. Similarly, fluid sealing may be provided between the respective ionization tubes 13 and manifolds 142,143 as was described above with respect to the seal 108 in FIG. 13.

The electrical source 12 is connected to the respective interior and exterior electrodes 45,16 in the bi-polar arrangement described above with respect to the ionizer system 100 with FIG. 13. Therefore, the bank of ionization assemblies 11a are operated on one half cycle to charge and then to discharge into the air in the space 23 between respective electrodes, and the lower bank of ionization assemblies 11b charge and discharge into the air in the space 23 thereof on the opposite half cycle of the electrical power.

The manifolds 142,143 of the respective upper and lower banks of the ionization assemblies 11a, 11b are hollow so as to allow for the flow of air and/or ionized species or constituents thereof. More particularly, the hollow internal passage 152 illustrated schematically in FIG. 17, in the manifold 142 allows the flow of air to the ionization tubes 13. A supply of such air may be provided from openings 153 in a side wall 154 of the manifold 142. The manifold 143 is similar to the manifold 142, in that it includes a hollow interior passage through which air and ionized species or constituents of the air may flow from the ionization tubes 13; and such flow may exit the manifold 143 via openings 155 in a side wall 156 thereof.

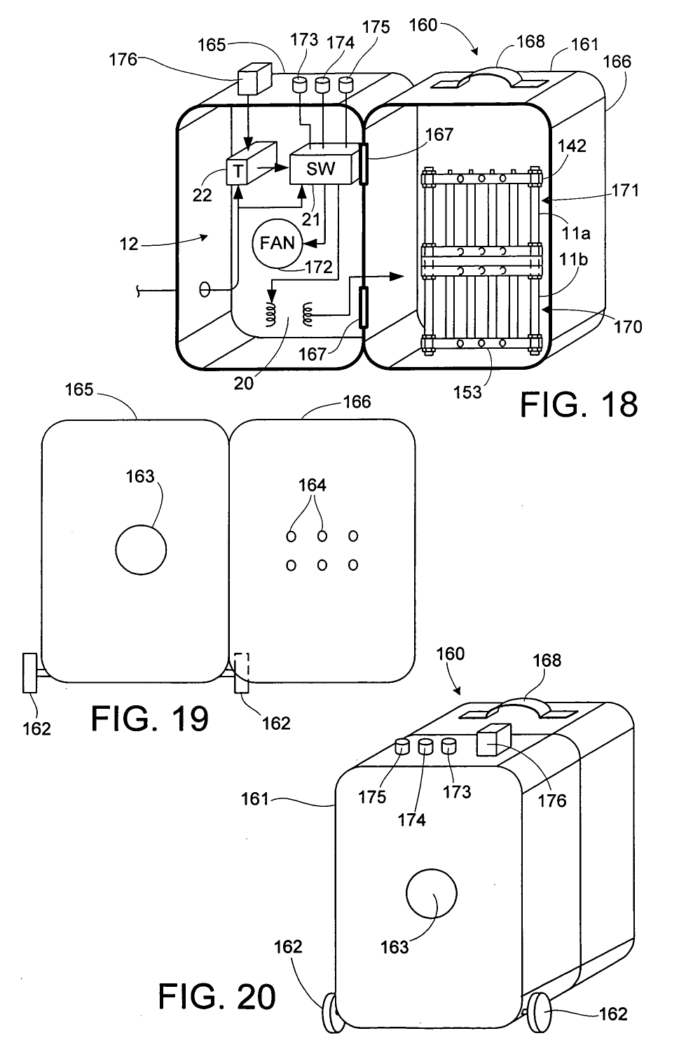

Referring now to FIGS. 18-20, a portable ionizer 160 in accordance with the present invention is illustrated. The portable ionizer 160 includes a case 161 that may be mounted on wheels 162. An opening 163 in one face of the case provides an inlet for air into the case, and a series of openings 164 in another wall of the case provides for outlet of ionized nitrogen or other species from the case. The case may be formed in two halves 165,166 which are attached by hinges 167. The case 161 also may include a handle 168. The output of all of the discharge tubes may also be funneled into a single discharge tube so that a hose may be attached and the exhaust directed in a focused manner.

In the interior 170 of the case 161 is an ionizer system 171 and an electrical source 12. The ionizer system 171 may be the same as the ionizer system 140 described above with respect to FIGS. 16 and 17. Alternatively, the ionizer system 171 illustrated in FIG. 18 may include one or more other features, electrodes, arrangement of ionizers, ionization tubes, electrodes, etc. such as, for example, those described above. For brevity, however, the ionization system 171 is the same as that described above with respect to the ionization system 140 of FIG. 18.

The electrical source 12 includes a power transformer 20 such as, for example, a transformer of the type used to energize neon signs. Other types of transformers may be used provided they have adequate power, step up voltage, current capacity, and so forth for operation of the ionization system 171. The electrical source 12 also includes an on/off switch or power control switch 21 and a timer control 22.

A fan 172 is mounted relative to the opening 163 so as to draw into the case 161 air from the outside ambient, such as, for example, air in a room that is intended to be deodorized. The fan 172 is operated by the timer control 22 and the on/off switch 21. A number of lights 173-175 on the top of the case 161 indicate the operative condition of the portable ionizer 160. A start switch 176 also is mounted on the case 161.

During operation of the portable ionizer 160, the case 161 is closed to be in the condition illustrated in FIG. 20. The fan 172 draws air through the opening 163 and into the case interior 170 so as to pressurize the case. The pressurized air then enters the ionization system 171 via the openings 153 in the inlet manifolds 142. The air flows through the ionization tubes 11a, 11b, and the air or constituents thereof becomes ionized and exits the portable ionizer 160 via the outlet manifolds 143, openings 155 therethrough and openings 164 through the side wall of the case 161. If the portable ionizer 160 ionizes nitrogen, the ionized nitrogen tends to flow throughout or to permeate the room in which the portable ionizer is located and deodorizes the room.

It is desirable to operate the portable ionizer 160 so as to produce ionized nitrogen in a room when the room is uninhabited. Therefore, the timer control 22 and the switch 21 provide for automated operation, for example, as is described below. The start switch 176 may be pressed to commence operation. The timer control 22 then operates through the switch 21 to turn on the fan for a prescribed period of time so as to pressurize the interior 170 of the case 161. A first light 173 indicates that such preliminary stage of operation has begun; this may be an indication to a user to leave the local area. After a period of time has elapsed which allows individuals in the room to depart, the timer control 22 operates the switch 21 so as to maintain operation of the fan 172 and also to provide power to the power supply transformer 20 in order to operate the ionization system 171 in the manner described above. Air flows through the ionization tubes 13, becomes ionized (for example, the nitrogen therein becomes ionized nitrogen) and the ionized nitrogen species and other constituents of the air exit the case 161 via the openings 164 to effect deodorization functions. While the ionization system 171 is operating to produce ionized nitrogen, for example, the timer control 22 and switch 21 operate the signal light 174 to indicate such operation. The light 173 may be extinguished at that time or may be allowed to remain illuminated to indicate that the fan 172 is operating.

After a prescribed period of time, which may be set by the user with the timer/control 22 or otherwise may be factory preset in the timer/control 22, the timer/control 22 and switch 21 operate to discontinue power to the power supply transformer 20, thus turning off the ionization system 171 so as to stop producing ionized nitrogen and/or other ionized species. The fan 172 may remain on for a period of time in order to fully eliminate all ionized fluid from the case 161 and ionization system 171. During the latter timeframe the signal light 174 can be extinguished and the signal light 175 can be illuminated to indicate that the system is going through a final venting stage and will shut down shortly. When the system has concluded operation, all lamps 173-175 may be extinguished. It will be appreciated that other types of procedures of operation and/or signaling functions may be used in accordance with the present invention.

In another embodiment, the fan blows the input air directly onto the banks of reactor tubes, thereby cooling them. In effect, the inlet fan pressurizes the case as a plenum to hold the tubes and provide direct cooling over the tubes and use the same fan to feed the tubes. The airflow is then channeled through the tubes and funneled into a single discharge tube.

The ionized nitrogen may be allowed to remain in the room to which it was provided in order to obtain the desired deodorizing function. After a period of time suitable to allow for the dissipation of the ionized nitrogen and nitric acid that may have been created, the room may be entered and surfaces wiped of any remaining residue left after the formation of the nitric acid.

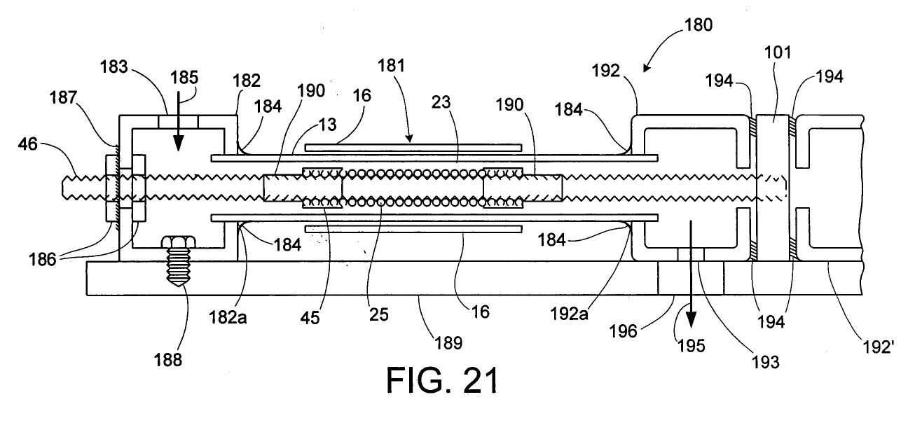

Turning now to FIG. 21, another ionizer system 180 is illustrated. The ionizer system 180 includes a single ionization assembly 181; however, the assembly contemplates the addition of another ionization assembly mounted in reverse direction to the right side of the current assembly. The ionizer system 180 is of a similar type to those systems illustrated in FIGS. 15, 16, and 18 and may be used in place of the respective ionizer used in those embodiments. In greater detail, the ionization assembly is secured to an input collection plenum 182, wherein the ionizer tube 13 is inserted into the collection plenum through opening 182a. The junction is sealed against leakage by a silicon seal 184. The plenum 182 is secured to an insulator plate 189 using a threaded fastener 188. The interior electrode 45 is secured the plenum 182 through an opening and is fastened in place by two nuts 186 mounted on the threaded rod 46. An aluminum tape conductor 187 can be used to connect the interior electrode to the power source. Heat-shrink tubing 190 is used to secure the wire 25 to the threaded rod 46. At the other end of the ionizer assembly 181, the opposing end of the ionizer tube 13 is inserted into the exhaust plenum 192 through the opening 192a. This end is likewise sealed with the silicone seal 184. The base end of the threaded rod 46 is securely mounted to the insulator 101, which in turn is secured in place to the insulator plate 189. The exhaust plenum is held in place by the adhesive 194. During operation, input air 185 enters the collection plenum 182 through the opening 185. The air passes through the ionizer tube 13 within the space 23 during the ionization process and enters as an ionized mix 195 into the exhaust plenum 192 and is exhausted through the openings 193 and 196.

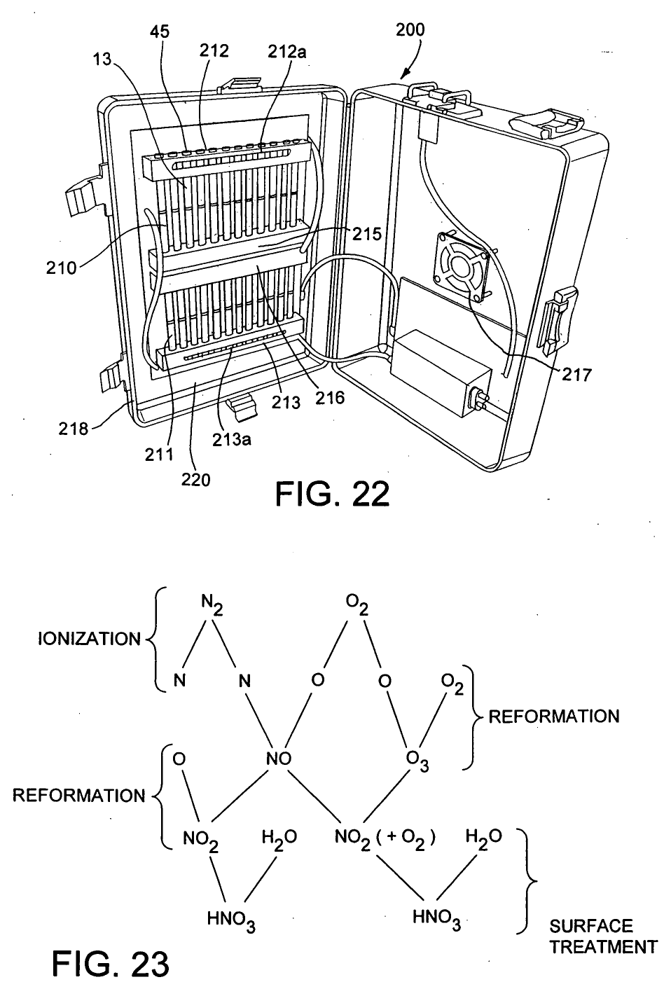

An additional embodiment of a portable ionizer 200 is illustrated in FIG. 22. The portable ionizer 200 in FIG. 22 reflects the modular nature of the construction and depicts the upper and lower banks of the ionizer tubes, 210, 211, each including eleven tubes each. The construction of the portable ionizer 200 reflects the construction of the ionizer assembly of FIG. 21, but can also utilize the other ionizer assemblies disclosed herein.

In the portable ionizer 200, the collection plenums 212, 213 and the exhaust plenums 215, 216 are used not only to mount the glass ionizer tubes 13, but also one side of the collection plenum 212 is used to locate the interior electrode 45. On both sides of the glass ionizer tubes 13, a square tube or plenum is used to hold the glass dielectric 13 and locate the interior electrode 45. The square tubes 212, 213, 215, 216 are also used to mount the ionizer tubes 13 directly onto the case wall, and the air flows through the holes (not shown) in the case wall 220 and out into the room on the opposite side of the exhaust plenums 215,216. All four fiberglass plenum's 212, 213, 215, and 216 are fastened to the case wall 220 so as to hold them in position. Each of the rectangular plenums have interior hollow passages, as in plenums 182, 192 of FIG. 21 so as to allow for fluid flow relative to the glass tubes 13. The air enters into the opening slots 212a, 213a of FIG. 22, passes through the glass tubes 13, is ionized, and the ionized nitrogen is collected in the exhaust plenums 215, 216. The ionized gas mixture exits to the rear of the exhaust plenums 215, 216 (not shown) to be collected into one output and then continues out through an opening to return to the atmosphere.

The ionizer tubes 13 of FIG. 22 may have approximately ⅝ inch outer diameter with a standard wall thickness of 1 mm. The size was chosen based on convenience, ⅝ inch diameter glass tubes are standard sizes. While these sizes were selected for convenience, the design is limited only by the availability of parts and a well-designed, preselected gap between the interior electrode 45 and the external field generator electrode 16.

A muffin fan 217 draws in input air from an external source and slowly circulates the air through the portable ionizer 200 device, including through the ionizer tubes 13, and out through the exhaust plenums 215, 216. An exemplary flow rate is approximately 20 to 30 CFM, however, higher velocity device may be constructed using a blower/compressor in place of the muffin fan 217, or using an exit mounted fan or blower to draw air through the device rather than push it through. When the portable ionizer 200 is closed, a perimeter seal 218 ensures that a pressurized interior is maintained while the muffin fan 217 is operating. An exterior booster fan is recommended in order to circulate the gas mixture throughout the room for enhanced deodorization and elimination of mold.

Additionally, a filtering mechanism may be unnecessary to filter air entering the portable ionizer 200 at the muffin fan 217. The ionizer tube is tolerant of debris accumulation in the tube. For example, if the interior electrode 45 is a zinc-coated wire, such an electrode may produce corrosion products. The corrosion products tend to migrate to the downstream end of the tube and tend to build up in clumps. The clumps do not, however, affect the operation of the apparatus. The self-limiting effect of the electrode 45 that limits the amount electron dispersal during discharge is a reason. Even when debris collects such that the apparatus wants to arc through that hot spot, the apparatus still fires evenly through the rest of the tube, and it does not destructively lead to burning or damage any of the apparatus. This interior electrode 45 will tend to arc in that spot, burn the debris away, but not create a hotspot so as to affect the dielectric material 13.

The interior electrode may be made of stainless steel that tends to reduce the amount of such debris.

gas ionizer apparatus disclosed herein may ionize oxygen and also ionizes nitrogen. When the gas, e.g., air, flows through the ionizing tubes the oxygen and nitrogen in their normal state N₂ and O₂ broken into singlets, N and O See FIG. 23. After passing through the device, the O combines with O₂ form ozone, O₃, and the N combines with O to form NO, nitric oxide. Ionized oxygen and NO combine to form NO₂. Also, the NO may then combine with the ozone O₃ to form NO₂ and oxygen O₂ as a doublet. The NO₂ that is formed be either process is very hydrophilic. It will combine with any substance or material that has moisture in it to form nitric acid, HNO₃. This formation of a layer of nitric acid at the surface of a hydrated material (e.g., bacteria, mold, any surface with moisture on it) causes a desiccating affect. It draws the moisture out of whatever hydrated material is being treated and dries it out. The drying at or on the surface caused by the formation of the nitric acid is effective at killing odors and killing and controlling mold, e.g., on contact.

It will be appreciated that the present apparatus and method may be used to create ionized nitrogen and/or other ionized gases or possibly other fluids and to use those fluids in various productive ways, such as performing deodorizing functions and for controlling mold.

In addition to room treatment, the apparatus can be used for surface treatment. In its ionized state, NO₂ is attracted to anything with water content because it forms nitric acid. If there is moisture on a surface, or even humidity condensation, a mono-molecular film of nitric acid will form using the moisture extracted from the surface. In addition to extracting moisture from a surface, the same reaction can be used to destroy bacteria, by removing the moisture content of the living cells.

Some other aspects of the invention include the following.

One aspect of the invention relates to apparatus for ionizing fluid, including: a pair of electric discharge devices that discharge electricity into a fluid that flows there through, each of the pair of electric discharge devices having a field electrode and a discharge electrode, and an electrical connection for providing AC electrical power to the electrodes of the pair of electric discharge devices, wherein the first electric discharge device of the pair provides electrical discharge into the fluid therein during a portion of one polarity of the AC electrical power while the second electric discharge device is substantially non-conducting of electrical power, and wherein the second electric discharge device provides electrical discharge into the fluid therein during a portion of the opposite polarity of the AC electrical power while the first electric discharge device is substantially non-conducting of electrical power.

Another aspect of the invention relates to a method of ionizing gas including the steps of: directing gas into at least two respective electric discharge devices that include field and discharge electrodes, supplying AC electrical power to the electric discharge devices such that during one polarity of the AC power a first electric discharge device discharges and a second discharge device tends to block current flow, and supplying AC electrical power to the electric discharge devices such that during the opposite polarity of the AC power the second electric discharge device discharges and the first electric discharge device tends to block current flow.

Another aspect of the invention relates to a method of deodorizing an area or eliminating mold by providing in the area a gas mixture including a concentration of ionized nitrogen such that it causes a layer of nitric acid to be formed on any moist surfaces in the area.

Another aspect of the invention relates to a method of deodorizing an area or eliminating mold by providing in the area a gas mixture including a concentration of ionized nitrogen that causes dessication of moist organic material during the formation of a layer of nitric acid.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. It will be appreciated that features of one or more embodiments may be used with one or more other embodiments hereof.

Although the invention is shown and described with respect to a number of exemplary embodiments, it is obvious that equivalents and modifications will occur to others skilled in the art upon the reading and understanding of the specification. The present invention includes all such equivalents and modifications, and is limited only by the scope of the claims.

I claim:

1. Apparatus for ionizing fluid, comprising:
a pair of electric discharge devices that discharge electricity into a fluid that flows there through,
each of the pair of electric discharge devices having a field electrode and a discharge electrode, and
an electrical connection for providing AC electrical power to the electrodes of the pair of electric discharge devices, wherein the first electric discharge device of the pair provides electrical discharge into the fluid therein during a portion of one polarity of the AC electrical power while the second electric discharge device is substantially non-conducting of electrical power, and wherein the second electric discharge device provides electrical discharge into the fluid therein during a portion of the opposite polarity of the AC electrical power while the first electric discharge device is substantially non-conducting of electrical power.

2. The apparatus of claim 1, wherein there are a plurality of pairs of electric discharge devices, each pair having first and second electric discharge devices.

3. The apparatus of claim 2, further comprising a case containing the electric discharge devices.

4. The apparatus of claim 2, further comprising a plenum for fluidically coupling a plurality of the first electric discharge devices, and a further plenum for fluidically coupling a plurality of the second electric discharge devices.

5. A method of ionizing gas comprising:
directing gas into at least two respective electric discharge devices that include field and discharge electrodes,
supplying AC electrical power to the electric discharge devices such that during one polarity of the AC power a first electric discharge device discharges and a second discharge device tends to block current flow, and
supplying AC electrical power to the electric discharge devices such that during the opposite polarity of the AC power the second electric discharge device discharges and the first electric discharge device tends to block current flow.

6. A method of deodorizing an area or eliminating mold by providing in the area a gas mixture including a concentration of ionized nitrogen such that it causes a layer of nitric acid to be formed on any moist surfaces in the area.

7. A method of claim 6, wherein the formation of a layer of nitric acid causes dessication of moist organic material.
